(19) United States
(12) Patent Application Publication
(10) Pub. No.: US 2010/0304579 A1
(43) Pub. Date: Dec. 2, 2010

(54) Low Resistance Connector For Printed Circuit Board

(76) Inventor: Brian Lyle Kisling, Phoenix, AZ (US)

Correspondence Address: CORNING INCORPORATED, SP-TI-3-1, CORNING, NY, 14831, US

(21) Appl. No.: 12/471,697

(22) Filed: May 26, 2009

(51) Int. Cl. H01R 12/00

(52) U.S. Cl. 439/63

(57) ABSTRACT

An electrical connector has first and second connector bodies. The first connector body has at least one groove and the second connector body has cantilevered arms that correspond to the groove. To unmate the connector bodies, the cantilevered arms are pressed causing the arms to move from the groove to allow the connector bodies to be moved axially away from one another.

### BACKGROUND OF THE INVENTION

1. Field of the Invention

The present invention relates generally to low resistance connectors for printed circuit boards, and particularly to connectors that require lower resistance to mate and unmate the connector from printed circuit boards and only when the unmating of the connector from the printed circuit board is desired.

2. Technical Background

Coaxial connectors are used to connect with electrical connectors on printed circuit boards (PCBs). The electrical connectors on the PCBs are soldered to metallic traces on the PCBs, which in turn are laminated to the board material. Typical electrical connections between the PCB connector and coaxial connectors are of the push-pull type. These connections are known to cause a delamination of the soldered connections and the metallic traces on the PCBs themselves when the connectors are unmated due to the typically higher resistance required to unmate them.

Prior coaxial connectors used on PCBs have attempted to solve this problem by making the connection between the coaxial cable and the electrical connector easier to unmate (easier to pull), but that allowed the coaxial cable to become unmated when it was not desired, causing an unwanted interruption of the electrical systems. Other attempts to provide a stable connection have been to secure the connectors after they have been assembled. One such attempt includes use of an epoxy to encase the mated connector pair. This procedure can be costly as well as time consuming. Additionally use of epoxy encasement makes disconnection for repair and/or replacement difficult if not impossible rendering the whole interconnect system virtually useless.

It would be desirable therefore to provide an electrical connector that can be used on PCBs that allows for easy unmating of the connector only at desired times.

### SUMMARY OF THE INVENTION

Disclosed herein is an electrical connector for connecting a printed circuit board and a coaxial cable that includes a first connector body having a front end and a back end and an opening extending therebetween, the first connector body having an outside surface with a generally circular cross section and at least one groove extending at least partially around the outside surface, and a second connector body having an outer sleeve portion configured to be mounted on the coaxial cable and having at least one cantilevered arm extending from the outer sleeve portion and configured to engage the at least one groove on the first connector body to prevent axial movement of the first and second connector bodies relative to one another when the first connector body and second connector body are connected.

In some embodiments, the electrical connector has two cantilevered arms and two grooves or a groove that extends around the outside surface.

In some embodiments, there is an outer conductor attached to the coaxial cable and the outer sleeve portion is attached to the outer conductor.

In another aspect, an electrical connector is disclosed for connecting a printed circuit board and a coaxial cable that includes a first connector body electrically connected to the printed circuit board, the first connector body having a front end and a back end and an opening extending therebetween, the first connector body having an outside surface with a generally circular cross section and at least one groove extending at least partially around the outside surface, and a second connector body having an outer sleeve portion mechanically connected to the coaxial cable and having at least one cantilevered arm extending from the outer sleeve portion and configured to engage the at least one groove on the first connector body to prevent axial movement of the first and second connector bodies relative to one another when the first connector body and second connector body are connected.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a cross sectional view of one embodiment of an electrical connector according to the present invention in an unmated position;

FIG. 2 is a cross sectional view of the electrical connector of FIG. 1 as the two connector bodies are about to engage one another;

FIG. 3 is a cross sectional view of the electrical connector of FIG. 1 in a partially engaged position;

FIG. 4 is a cross sectional view of the electrical connector of FIG. 1 in a fully engaged position;

FIG. 5 is a cross sectional view of the electrical connector of FIG. 1 with the connector bodies about to be separated with little force;

FIG. 6 is a cross sectional view of another embodiment of a first connector body of an electrical connector according to the present invention; and

FIG. 7 is a perspective view of another embodiment of a second connector body of an electrical connector according to the present invention.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

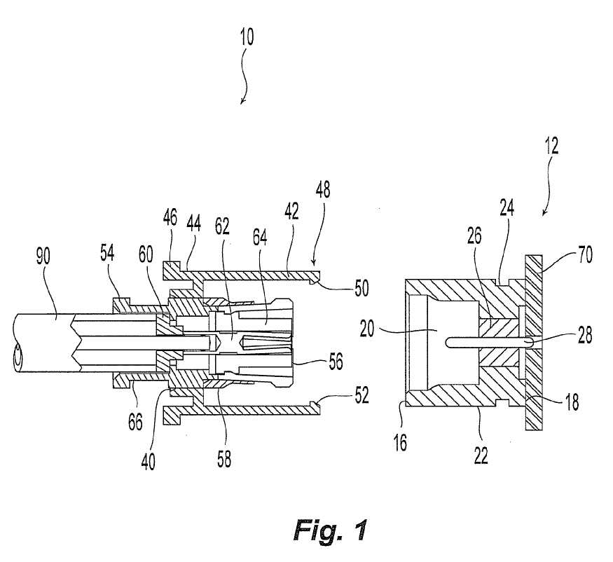

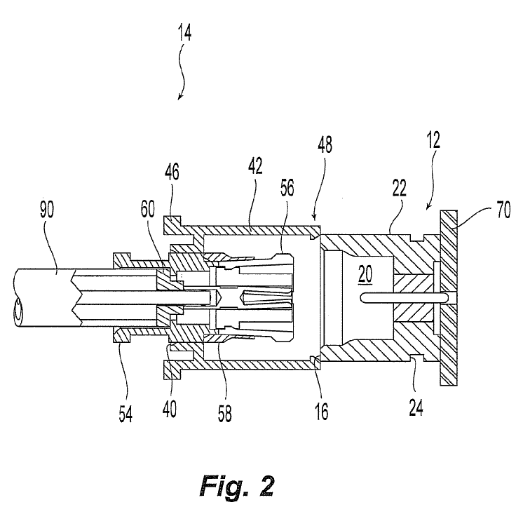

Referring to FIGS. 1 and 2, an electrical connector 10 has a first connector body 12 and a second connector body 14. The first connector body 12 has a front end 16 and a back end 18, with an opening 20 extending therebetween. The first connector body 12 has an outside surface 22 that has a generally circular cross-section and at least one groove 24 that extends at least partially around the outside surface 22. While the at least one groove 24 preferably extends all the way around the outside surface 22 of the first connector body 12 in an uninterrupted manner, the at least one groove 24 may include multiple shorter grooves that extend around the outside surface 22. Alternatively, there could be two grooves 24 on opposing sides of the first connector body 12.

The first connector body 12 is preferably mechanically and electrically connected to a printed circuit board 70. Disposed within the opening 20 is a dielectric 26 and a pin 28. Both the first connector body 12 (at the back end 18) and the pin 28 are preferably soldered to the printed circuit board 70.

The second connector body 14 has an outer sleeve portion 40 that is configured to be mounted on a coaxial cable 90. Extending from the outer sleeve portion 40 is at least one cantilevered arm 42, which is to engage the at least one groove 24 on the first connector body 12. Preferably, the second connector body 14 has two cantilevered arms 42 that are on opposite sides of the second connector body 14. The cantilevered arm 42 has a rearward extending portion 44 that terminates with a press tab 46. The cantilevered arm 42 also has a forward extending portion 48 that terminates with a downward projection 50 to engage the groove 24. Preferably, the forward surface of downward projection 50 also includes a chamfered portion 52, which assists in connecting the two connector bodies as described further below.

As illustrated in the figures, the coaxial cable 90 also has attached thereto an outer conductor 54 that includes a finger sleeve portion 56. Anti-rock ring 58, dielectric stop 60, center conductor 62, and insulator 64 may also be used with coaxial cable 90. While these are components of a solder-on type connector, other type connectors, including a compression or crimp style connector, may be used with the second connector body 14.

Preferably, the first connector body 12 and the second connector body 14 are made of Kovar and are plated with a conductive material such as gold. In that case, the second connector body 14 is press-fit on to outer conductor 54. It is also possible, that the second connector body 14 be integral with the outer conductor 54. However, it is possible that the second connector body 14 be made of plastic material. If the second conductor body 14 were to be made of plastic, the outer sleeve portion 40 would preferably be disposed in the circumferential groove 66 in the outer conductor 54 and directly on coaxial cable 90. This would allow for the second conductor body 14 to spin around in the circumferential groove 66 in the outer conductor 54. Naturally, moving the outer sleeve portion 40 rearward relative to the coaxial cable 90 would require that the cantilevered arms 42 be longer than illustrated in the current figures. Additionally, the diameter of the outer sleeve portion 40 could be reduced even further and the second conductor body 14 could be positioned behind the outer conductor 54. Again, the cantilevered arms 42 would have to be even longer in order to engage to groove 24 in the first connector body 12.

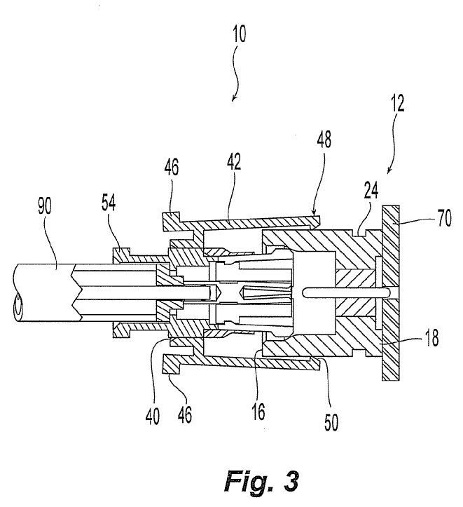

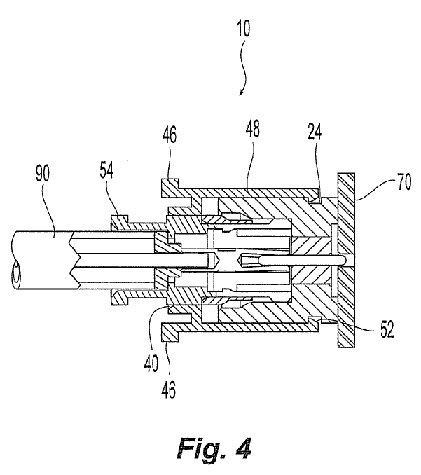

Referring to FIG. 2, the first connector body 12 and the second connector body 14 are moved closer relative to one another. The chamfered portion 52 is aligned with the front end 16 of first connector body 12. As the two connector bodies are moved toward one another, the downward projection 50 of forward extending portion 48 moves over and along the outside surface 22 of the first connector body 12. See FIG. 3. The cantilevered arms 42 are biased inward so they maintain contact with the outside surface 22 of the first connector body 12. As a coaxial cable 90 is inserted into the opening 20 (including the finger sleeve portion 56), the downward projections 50 will engage the groove 24 as illustrated in FIG. 4. As also illustrated in FIG. 4, the finger sleeve portion 56 engages the end of opening 20 and the pin 28 engages the center conductor 62, thereby preventing axial movement of the two conductor bodies relative to one another. Inserting the first conductor body between the cantilevered arms 42 of the second conductor body 14 requires minimal force. Detaching the two conductor bodies from one another also requires minimal force.

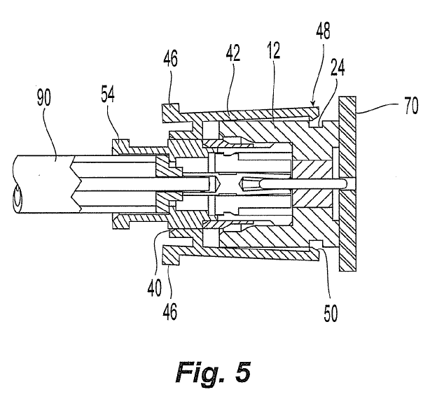

As illustrated in FIG. 5, a user must merely push on the press tabs 46 causing the forward extending portion 48 to move away from the outer surface 22 of the first conductor body 12 such that the downward projections 50 clear the groove 24. Very little force is then required to disengage the finger sleeve portion 56 from the opening 20 as well as the center conductor 62 from the pin 28.

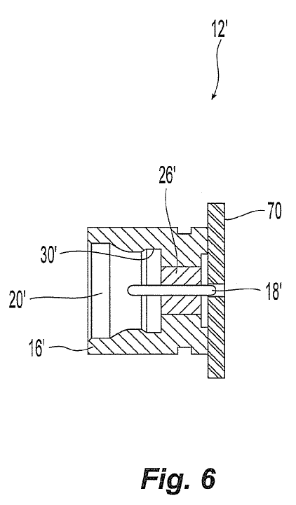

An alternative embodiment of the first conductor body 12′ is illustrated in FIG. 6. In this embodiment, the first conductor body 12′ has a front end 16′ and a back end 18′ with an opening 20′ extending therebetween. The first conductor body 12′ is also connected to a printed circuit board 70 as discussed above. The first conductor body 12′ has in the opening 20′, adjacent to the dielectric 26′, a detent 30′ to capture projections on the finger sleeve portion 56. This configuration further assists in preventing axial movement of the two connector bodies once connected.

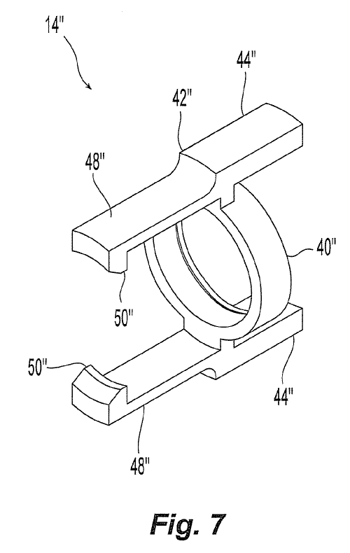

Illustrated in FIG. 7 is an alternative embodiment of the second connector body 14″. The second connector body 14″ has an outer sleeve portion 40″ and preferably two cantilevered arms 42″. The two cantilevered arms 42″ (as well as the downward projections 50″) have a curvature that corresponds to the outside surface 22 of the first connector body 12. While the cantilevered arms 42″ and the downward projections 50″ can be straight or curved, the curved configuration allows the downward projections 50″ to better engage the groove 24 by having more contact with the groove 24. The forward extending portion 48″ of the cantilevered arms 42″ are illustrated as having the same curvature as the outside surface 22 in FIG. 7, but the rearward extending portion 44″ may be straight or curved.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. An electrical connector for connecting a printed circuit board and a coaxial cable comprising:
a first connector body having a front end and a back end and an opening extending therebetween, the first connector body having an outside surface with a generally circular cross section and at least one groove extending at least partially around the outside surface; and
a second connector body having an outer sleeve portion configured to be mounted on the coaxial cable and having at least one cantilevered arm extending from the outer sleeve portion and configured to engage the at least one groove on the first connector body to prevent axial movement of the first and second connector bodies relative to one another when the first connector body and second connector body are connected.

2. The connector according to claim 1, wherein the at least one cantilevered arm includes two cantilevered arms, the two cantilevered arms being on opposite sides of the outer sleeve portion and the at least one groove includes two grooves.

3. The connector according to claim 1, wherein the at least one cantilevered arm includes two cantilevered arms, the two cantilevered arms being on opposite sides of the outer sleeve portion and the at least one groove extends around the outside surface.

4. The connector according to claim 1, further comprising:
an outer conductor configured to be attached to the coaxial cable, the outer sleeve portion of the second connector body being attached to the outer conductor.

5. The connector according to claim 4, the outer conductor having a circumferential groove and the outer sleeve portion being disposed in the circumferential groove.

6. The connector according to claim 5, wherein the second connector body rotates relative to the outer conductor.

7. The connector according to claim 1, wherein the at least one cantilevered arm has a curved configuration that corresponds to the outer surface of the first connector body.

8. The connector according to claim 1, wherein pressing on a back portion of the at least one cantilevered arm disengages the second connector body from the first connector body.

9. The connector according to claim 1, wherein a distal end of the at least one cantilevered arm has a chamfered surface.

10. An electrical connector for connecting a printed circuit board and a coaxial cable comprising:
a first connector body electrically connected to the printed circuit board, the first connector body having a front end and a back end and an opening extending therebetween, the first connector body having an outside surface with a generally circular cross section and at least one groove extending at least partially around the outside surface; and
a second connector body having an outer sleeve portion mechanically connected to the coaxial cable and having at least one cantilevered arm extending from the outer sleeve portion and configured to engage the at least one groove on the first connector body to prevent axial movement of the first and second connector bodies relative to one another when the first connector body and second connector body are connected.

11. The electrical connector according to claim 10, wherein the coaxial cable has an outer conductor mechanically attached thereto and the outer sleeve portion of the second connector body is mechanically attached to the outer conductor.

12. The electrical connector according to claim 10, wherein the at least one cantilevered arm includes two cantilevered arms, the two cantilevered arms being on opposite sides of the outer sleeve portion and the at least one groove includes two grooves.

13. The electrical connector according to claim 11, the outer conductor having a circumferential groove and the outer sleeve portion being disposed in the circumferential groove.

14. The electrical connector according to claim 13, wherein the second connector body rotates relative to the outer conductor.

15. The electrical connector according to claim 10, wherein pressing on a back portion of the at least one cantilevered arm disengages the second connector body from the first connector body.
